(19) United States
(12) Patent Application Publication
(10) Pub. No.: US 2025/0295134 A1
(43) Pub. Date: Sep. 25, 2025

(54) FLEXIBLE NOZZLE FOR A MICRO PUREE MACHINE

(71) Applicant: SharkNinja Operating LLC, Needham, MA (US)

(72) Inventors: Lukas Tubby, Auburn, MA (US); Zachary Kelley, Boston, MA (US)

(73) Assignee: SharkNinja Operating LLC, Needham, MA (US)

(21) Appl. No.: 18/612,673

(22) Filed: Mar. 21, 2024

(51) Int. Cl. A23G 9/28

(52) U.S. Cl. CPC A23G 9/281

(57) ABSTRACT

A flexible nozzle includes a body and an opening extending through a width of the body. The opening has a central region and at least two arms extending radially from the central region. Each of the arms has two sidewalls extending from the central region and converging to a point such that a flap is formed between the at least two arm regions. The flap is configured to bend away from a top surface of the body along a fold line extending between the two arm regions when a force is exerted on the flap from the top surface.

### FIELD

The present disclosure relates to a food processing device and, more particularly, to a food processing device with a flexible nozzle for dispensing ingredients from the device.

### BACKGROUND

Domestic kitchen appliances that are intended to make ice creams, gelatos, frozen yogurts, sorbets and the like are known in the art. Typically, a user adds a series of non-frozen ingredients to a mixing bowl, which often has been previously cooled, for example, in a freezer. The ingredients are then churned by a one or more paddles (sometimes referred to as dashers) while a refrigeration mechanism simultaneously freezes the ingredients. These devices have known shortcomings including, but not limited to, the amount of time and effort required by the user to complete the ice cream-making process. Machines of this nature are also impractical for preparing most non-dessert food products.

An alternative type of machine known for making a frozen food product may be referred to as a micro puree machine. Typically, machines of this nature spin and plunge a blade into a pre-frozen ingredient or combination of ingredients. While able to make frozen desserts like ice creams, gelatos, frozen yogurts, sorbets and the like, micro puree machines can also prepare non-dessert types of foods such as non-dessert purees and mousses.

### SUMMARY

The disclosure, in various embodiments, addresses deficiencies associated with dispensing “soft serve” frozen ingredients from a micro puree machine when extruding the ingredients under manual or low pressure. The disclosure describes illustrative systems, methods, and devices that aid in the cutting of the extruded ingredients from the remaining frozen ingredients inside the processing bowl or nozzle during the extrusion process.

In embodiments, a flexible nozzle for a micro puree machine of this disclosure includes a body having a top surface. An opening extends through a width of the body. The opening has a central region and at least two arms extending radially from the central region. Each of the at least two arms has two sidewalls extending from the central region and converging to a point such that a flap is formed between the at least two arm regions. The flap is configured to bend away from the top surface of the body along a fold line extending between the two arm regions when a force is exerted on the flap from the top surface.

In further embodiments, the flap is configured to return to an unbent state when the force is no longer exerted on the flap. In embodiments, the body is made of silicone. In embodiments, the at least two arm regions is six arm regions. In embodiments, the sidewalls of each of the at least two arm regions are sloped between the top surface of the body and a bottom surface of the body. In embodiments, the body has outer circumference defining a shape of the body. In embodiments, the shape of the body is circular. In embodiments, a shape of the opening is one of a star, a flower and a sun.

Embodiments of a flexible nozzle system for a micro puree machine of this disclosure include an outlet in communication with an opening in a processing bowl of the micro puree machine, and a flexible nozzle disposed within the outlet. The flexible nozzle includes a body having a top surface and an opening extending through a width of the body. The opening has a central region and at least two arms extending radially from the central region. Each of the at least two arms has two sidewalls extending from the central region and converging to a point such that a flap is formed between the at least two arm regions. The flap is configured to bend away from the top surface of the body along a fold line extending between the two arm regions when a force is exerted on the flap from the top surface.

In further embodiments, the flap is configured to return to an unbent state when the force is no longer exerted on the flap. In embodiments, the body is made of silicone. In embodiments, the at least two arm regions is six arm regions. In embodiments, the sidewalls of each of the at least two arm regions are sloped between the top surface of the body and a bottom surface of the body. In embodiments, the body has outer circumference defining a shape of the body. In embodiments, the shape of the body is circular. In embodiments, the flexible nozzle system further includes a plug for selectively covering and uncovering an opening in the outlet. In embodiments, a shape of the opening is one of a star, a flower and a sun.

Notably, the mechanisms and techniques described herein may be used to configure a machine to process (e.g., micro puree and aerate) and extrude ice cream and other frozen ingredients. That is, both the aeration and extrusion functions can be performed by a single machine. In such a machine, a same shaft may be used to drive a blade to process the frozen ingredients and to drive a plunger to extrude the processed ingredients. Further, such a machine may include a user interface enabling a user to control the timing of the performance of each function. In some embodiments, to enable the performance of both functions, the user may need only to replace a first lid for processing from an open end of the processing bowl with a second lid for extruding, as described in more detail below. In other embodiments, to enable the performance of both functions, the user may need only to flip the processing bowl from a first arrangement, in which the driven shaft engages a blade at a first end of the processing bowl (e.g., the blade coupled to a lid at a first open end of the processing bowl), to a second arrangement, in which the driven shaft engages a plunger at a second end of the processing bowl (e.g., the plunger coupled to a lid at an open second end of the processing bowl. In still other embodiments, the driven shaft may selectively engage either the blade alone at a first end of the processing bowl (e.g., the blade coupled to a lid at an open end of the processing bowl), or both the blade and the plunger at the first end of the processing bowl (e.g., both the blade and plunger coupled to the lid at the open end of the processing bowl).

A reading of the following detailed description and a review of the associated drawings will make apparent the advantages of these and other structures. Both the foregoing general description and the following detailed description serve as an explanation only and do not restrict aspects of the disclosure as claimed.

### BRIEF DESCRIPTION OF THE DRAWINGS

Reference to the detailed description, combined with the following figures, will make the disclosure more fully understood, wherein:

FIG. 1 shows an assembled view of a micro puree machine including a processing bowl, according to some embodiments of the disclosure;

FIG. 2 is a detailed view of an interior coupling and a driven shaft of the micro puree machine, according to some embodiments of the disclosure;

FIGS. 3A and 3B show a method of inserting the processing bowl into the coupling, according to some embodiments of the disclosure;

FIG. 4 illustrates a blade and a plunger for use with the processing bowl, according to some embodiments of the disclosure;

FIGS. 5A and 5B are detailed views of an outlet of the processing bowl, according to some embodiments of the disclosure; and

FIGS. 6A-6G are detailed views of a flexible nozzle disposed within the outlet of the processing bowl, according to some embodiments of the disclosure.

### DETAILED DESCRIPTION

In the following description, like components have the same reference numerals, regardless of different illustrated embodiments. To illustrate embodiments clearly and concisely, the drawings may not necessarily reflect appropriate scale and may have certain structures shown in somewhat schematic form. The disclosure may describe and/or illustrate structures in one embodiment, and in the same way or in a similar way in one or more other embodiments, and/or combined with or instead of the structures of the other embodiments.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

The disclosure, in various implementations, addresses deficiencies associated with cutting extruded processed (e.g., frozen or semi-frozen) ingredients from the remaining processed ingredients in a processing bowl or nozzle as a user extrudes (i.e., dispenses) the ingredients from a micro puree machine. Some machines that extrude frozen or semi-frozen ingredients (e.g., ice cream) use a hard plastic nozzle to form a shape of the extruded ingredients as they are extruded from the machine. However, such machines typically also generate constant pressure towards the extrusion opening due to a rotating auger, making it relatively easy to cut frozen ingredients from the remaining ingredients in a processing bowl. In contrast, manual extrusion machines lack this constant pressure, making it more difficult to cut the frozen ingredients from the remaining ingredients in the processing bowl.

The various embodiments of the flexible nozzle of this disclosure solves these deficiencies by shaping the frozen ingredients as they are being extruded. The force of the extrusion causes the tips of the rubber nozzle to bend, which create, for example, a star shape. When the extrusion is paused or stopped, the force of extrusion is reduced, which allows for the tips of the flexible nozzle to return to their natural unbent state. This return to a natural state helps create a pointed tip at the end of the extrusion, cutting it from the remaining frozen ingredients in the processing bowl or pint. Advantageously, the flexible nozzle also helps make the extruded ingredients form an appetizing shape as they are dispensed from the processing bowl.

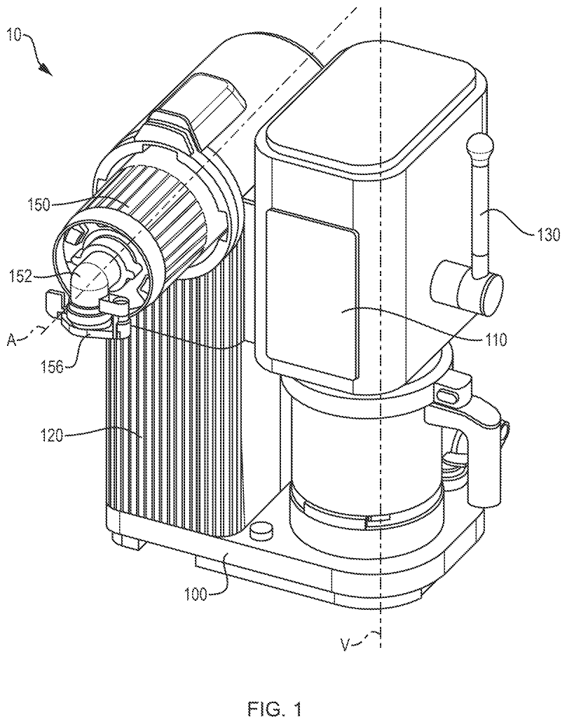

FIG. 1 shows an assembled view of a micro puree machine 10 according to some embodiments of the disclosure. The micro puree machine 10 may include a base 100 and a housing 120. The housing 120 may include a user interface 110 for receiving user inputs to control the micro puree machine 10 and/or display information. The micro puree machine 10 may also include a processing bowl 150, as further described below. The processing bowl 150 may contain one or more ingredients for processing. The processing bowl 150 may be assembled to the housing 120 such that a central axis A of the processing bowl 150 extends perpendicular to a vertical axis V of the housing 120, as shown. However, the disclosure contemplates that the processing bowl 150 may be assembled to the housing 120 such that the central axis A extends at an angle of between 0 and 90° to the vertical axis V, or such that the central axis A extends parallel to the vertical axis V. In embodiments, the processing bowl 150 can be manufactured from a disposable material to enhance the convenience of using the micro puree machine 10. Further, the processing bowl 150 can be sold as a stand-alone item and can also be prefilled with ingredients to be processed during use of the micro puree machine 10.

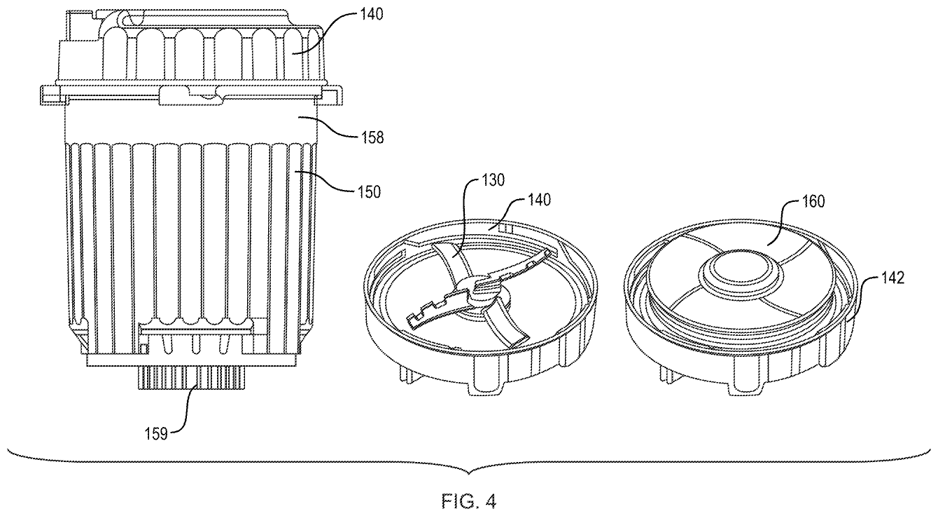

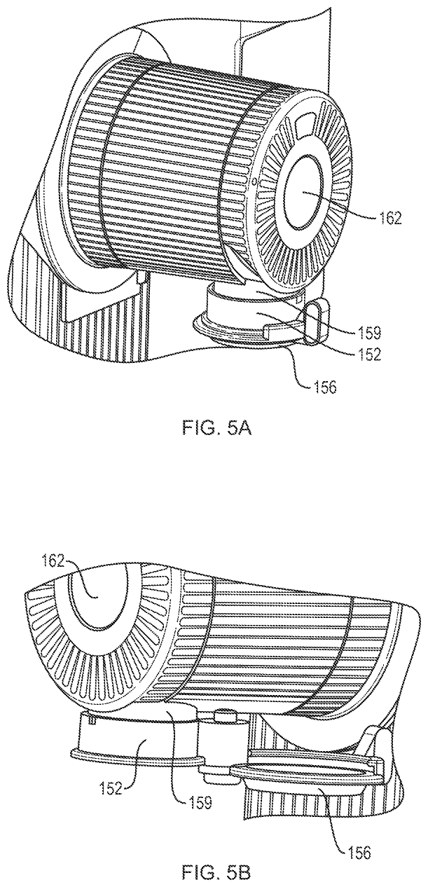

The processing bowl 150 may include an outlet 152 for extruding processed ingredients from the processing bowl 150. The micro puree machine 10 may also include a lever 130 for manually activating a plunger 160 (FIG. 4) to extrude processed ingredients within the processing bowl 150 through the outlet 152. The outlet 152 may be integrated with the processing bowl 150 or may be attachable thereto. An open end of the outlet 152 may be coverable with a hinged stopper or plug 156. In embodiments, the processing bowl 150 may be configured to be installed to the micro puree machine 10 such that the outlet 152 faces vertically downwards when the processing bowl 150 is properly installed. The outlet 152 may be selectively located on the processing bowl 150 to optimize the amount of processed ingredients that can be extruded, thus minimizing the amount of yield loss after extrusion. For example, the outlet 152 may be located either at a location along the central axis A (as shown) or near the bottom edge of the processing bowl 150 (FIGS. 5A, 5B). However, the disclosure also contemplates that the outlet 152 may alternatively be located at a different longitudinal and/or radial position on the processing bowl 150.

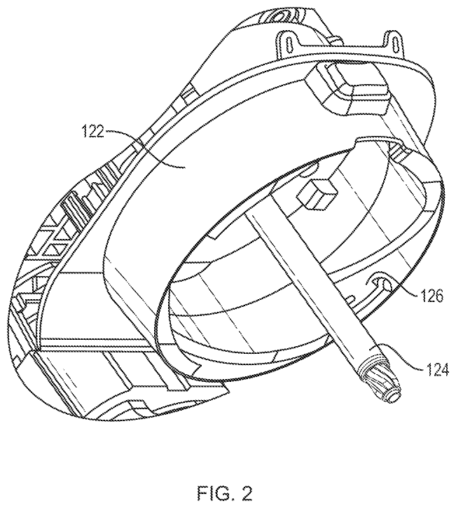

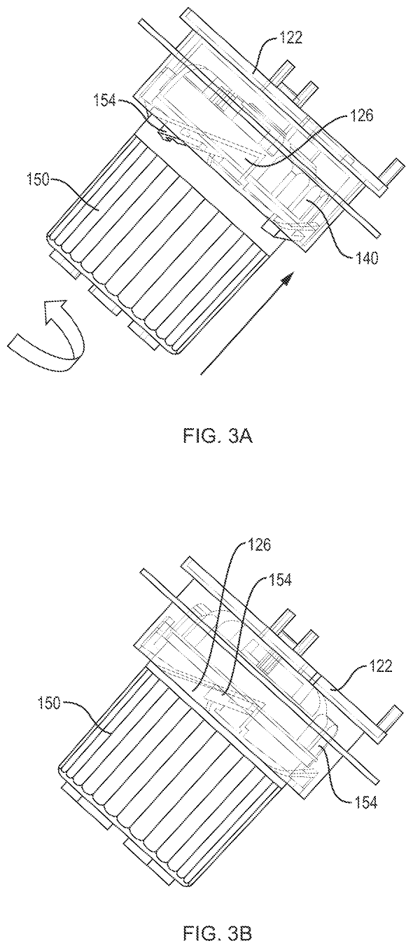

FIG. 2 is a detailed view of an interior coupling 122 and a driven shaft 124 of the micro puree machine 10 according to some embodiments of the disclosure. As shown in FIG. 2, the driven shaft 124 may extend through the coupling 122 to couple with either a blade or a plunger housed within a lid on the processing bowl 150. An inner surface of the coupling 122 may comprise one or more slots 126 sized to receive at least one corresponding projection 154 (FIGS. 3A and 3B) on an outer surface of the processing bowl 150. In embodiments, the at least one slot 126 may be four slots 126 spaced 90 degrees apart about the inner surface of the coupling 122 for receiving a corresponding one of four protrusions 154 on the processing bowl 150. However, the disclosure contemplates more or fewer than four slots 126 and projections 154.

FIGS. 3A and 3B show a method of inserting the processing bowl into the coupling 122, according to some embodiments of the disclosure. As shown in FIG. 3A, the user may rotate the processing bowl 150 relative to the coupling 122 in a first direction (e.g., clockwise) such that the protrusions 154 rotate into the slots 126, securing the processing bowl 150 to the coupling 122 (FIG. 3B). To remove the processing bowl 150 from the coupling 122, the user may rotate the processing bowl 150 in a second direction (e.g., counterclockwise) to release the bowl 150 from the coupling 122 after processing.

FIG. 4 illustrates a blade 130 and a plunger 160 for use with the processing bowl 150 according to some embodiments of the disclosure. As shown in FIG. 4, an open end 158 of the processing bowl 150 may be configured to couple to both a first lid 140 housing the blade 130 and a second lid 142 housing the plunger 160. The user may attach the first lid 140 to the processing bowl 150 and couple to the processing bowl 150 to the micro puree machine 10 as described with reference to FIGS. 3A and 3B. The driven shaft 124 (FIG. 2) may engage the blade 300 to descend the blade 300 within the processing bowl 150 to process (e.g., micro puree) the ingredients in the bowl 150. The user may then remove the processing bowl 150 from the micro puree machine 10 and remove the first lid 140. The user may then attach the second lid 142 to the processing bowl 150 and couple the processing bowl 150 to the micro puree machine 10. The driven shaft 124 may then engage the plunger 160 to descend the plunger 160 through the processed ingredients. This in turn may cause the processed ingredients to be extruded through an opening 159 in the processing bowl 150 and through the outlet 152.

FIGS. 5A and 5B are detailed views of an outlet 152 of the processing bowl 150 according to some embodiments of the disclosure. As shown in FIG. 5A, the plug 156 covering the outlet 152 may biased toward an open position but may be held and locked into the closed position with locking elements (not shown). To open the plug 156, the user may twist a cap 162 operatively coupled to the locking elements, causing locking elements to be released such that the plug 156 is sprung into the open position. When the plug 156 is in the open position, the user may extrude the processed ingredients through the opening 159 and the outlet 152 (FIG. 5B)

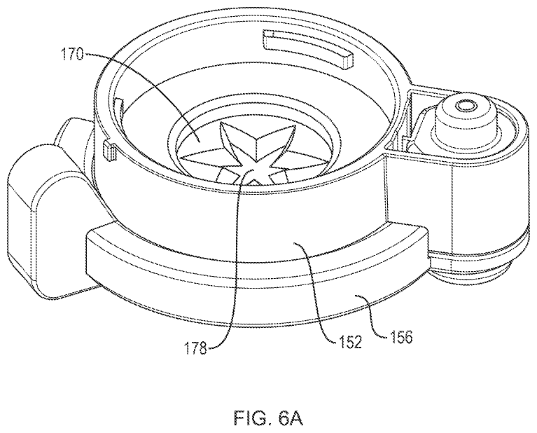

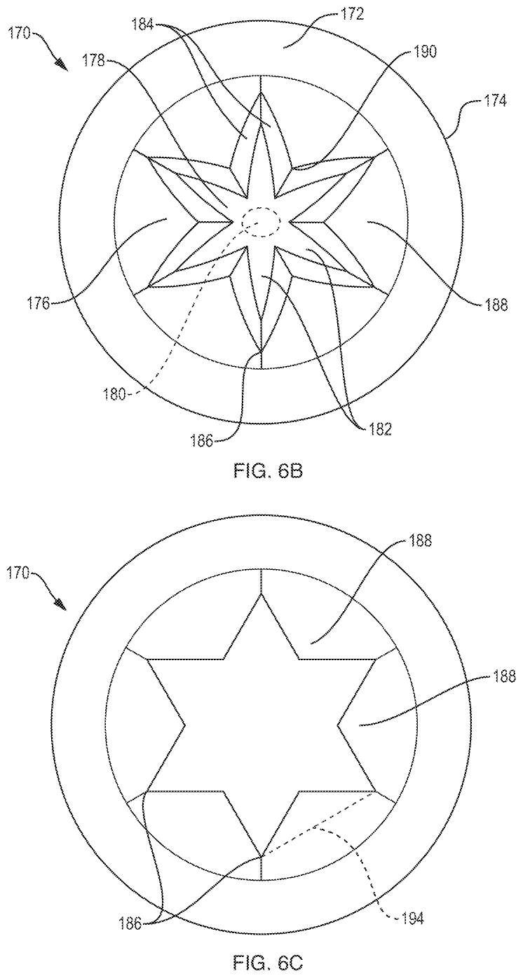

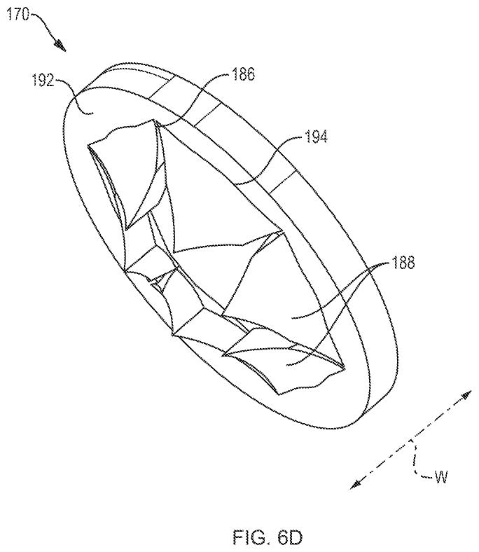

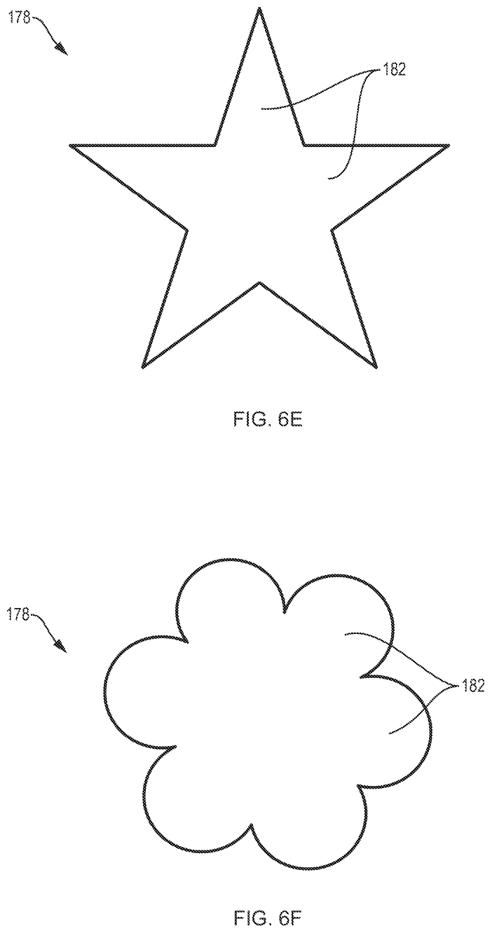

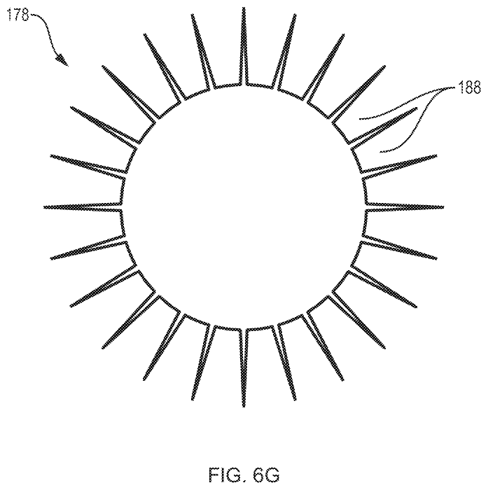

FIGS. 6A-6D are detailed views of a flexible nozzle 170 disposed within the outlet 152 of the processing bowl 150, according to some embodiments of the disclosure. In some embodiments, the flexible nozzle 170, the outlet 152, and the plug 156 collectively constitute a flexible nozzle system. As shown in FIG. 6A, the flexible nozzle 170 may be disposed within the outlet 152 such that the processed ingredients are forced through an opening 178 in the flexible nozzle 170 during the extrusion process. As shown in FIG. 6B, the flexible nozzle 170 may have a body 172 and an outer circumference 174 defining the shape of the body 172. In some embodiments, a cross-sectional shape of the body 172 may be circular, as shown. However, the disclosure contemplates other suitable cross-sectional shapes, such as square or rectangular, of the body 172. The body 172 may further include a top surface 176. For purposes of this disclosure, the top surface 176 may be the surface of the flexible nozzle 172 facing the opening 159 in the processing bowl 150. The body 172 may be comprised of a flexible material, such as rubber or silicone. However, the disclosure contemplates that the body 172 may be comprised of other flexible, food grade materials. The opening 178 may extend through a width W of the body 172. The opening 178 may have a central region 180 and at least two arm regions 182 extending radially from the central region 178. For example, the at least two arm regions 182 may be six arm regions 180 forming a six-pointed star shape, as shown. However, the disclosure contemplates more or fewer than six arm regions 182.

Each of the arm regions 182 may comprise two opposing sidewalls 184 extending from the central region 180 towards the outer circumference 174. The opposing sidewalls 184 may converge to a first point 186 such that a flap 188 is formed between adjacent arm regions 182. The number of flaps 188 may be six flaps, as shown. However, the disclosure contemplates more or fewer than six flaps 188. Each of the flaps 188 may also define a second point 190 adjacent the central region 180 of the opening 178. The sidewalls 184 of each of the arm regions 182 may be sloped between the top surface 176 of the body 172 and an opposing bottom surface 192 (FIG. 6D), as shown. However, the disclosure contemplates that the sidewalls 184 could also be straight sided.

As shown in FIGS. 6C and 6D, when the frozen ingredients are dispensed from the outlet 152 and through the flexible nozzle 170 (for example, when the user pulls on the lever 130), the force of the extruded ingredients causes the flaps 188 to bend away from the top surface 176 along a fold-line 194 extending between the first points 186. Once the extrusion stops, and the force is no longer applied, the flaps 188 may be configured to return to their original unbent shape. This return of the flaps 188 to their natural state helps create a pointed tip at the end of the extrusion and cut the extrusion from the remaining frozen ingredients in the processing bowl 150 or outlet 152.

The disclosure contemplates that the opening 178 may have shapes other than a six-pointed star shape. For example, the shape of the opening 178 may be a five-pointed star having five arms 182 (FIG. 6E). Alternatively, the shape of the opening may be a flower shape having six arms 182 (FIG. 6F) or more or fewer than six arms 182. A shape of the opening 178 may also be a sun shape forming 24 flaps 188 (FIG. 6G) or more or fewer than 24 flaps.

The disclosure contemplates that, in some embodiments (not shown), the bowl 352 can be coupled vertically in an inverted orientation (i.e., downward) on a top or upward-facing surface of the housing 120 whereby blade 300 moves up and then down to creamify, process, and/or mix ingredients in the bowl 352. The upward-facing surface may face vertically upward or be angled in an upward direction. In some embodiments, micro puree machine 10 may be configured to automatically detect a size of the bowl 352 and, in response to the detection, extend the blade 300 a depth and/or travel distance into the bowl 352 based on the detected size of the bowl 352. This bowl-size detection would advantageously enable the micro puree machine 10 to process ingredients in different sized containers, such as a single serve container or larger containers.

While the disclosure particularly shows and describes preferred embodiments, those skilled in the art will understand that various changes in form and details may exist without departing from the spirit and scope of the present application as defined by the appended claims. The scope of this present application intends to cover such variations. As such, the foregoing description of embodiments of the present application does not intend to limit the full scope conveyed by the appended claims.

What is claimed is:

1. A flexible nozzle for a micro puree machine, the flexible nozzle comprising:
a body having a top surface; and
an opening extending through a width of the body, the opening having a central region and at least two arms extending radially from the central region, each of the at least two arms having two sidewalls extending from the central region and converging to a point such that a flap is formed between the at least two arm regions;
wherein the flap is configured to bend away from the top surface of the body along a fold line extending between the two arm regions when a force is exerted on the flap from the top surface.

2. The flexible nozzle of claim 1, wherein the flap is configured to return to an unbent state when the force is no longer exerted on the flap.

3. The flexible nozzle of claim 1, wherein the body is comprised of silicone.

4. The flexible nozzle of claim 1, wherein the at least two arm regions is six arm regions.

5. The flexible nozzle of claim 1, wherein the sidewalls of each of the at least two arm regions are sloped between the top surface of the body and a bottom surface of the body.

6. The flexible nozzle of claim 1, wherein the body has outer circumference defining a shape of the body.

7. The flexible nozzle of claim 6, wherein the shape of the body is circular.

8. The flexible nozzle of claim 1, wherein a shape of the opening is one of a star, a flower and a sun.

9. A flexible nozzle system for a micro puree machine, the flexible nozzle system comprising:
an outlet in communication with an opening in a processing bowl of the micro puree machine; and
a flexible nozzle disposed within the outlet, the flexible nozzle comprising:
a body having a top surface; and
an opening extending through a width of the body, the opening having a central region and at least two arms extending radially from the central region, each of the at least two arms having two sidewalls, the sidewalls extending from the central region and converging to a point such that a flap is formed between the at least two arm regions;
wherein the flap is configured to bend away from the top surface of the body along a fold line extending between the two arm regions when a force is exerted on the flap from the top surface.

10. The flexible nozzle system of claim 9, wherein the flap is configured to return to an unbent state when the force is no longer exerted on the flap.

11. The flexible nozzle system of claim 9, wherein the body is comprised of silicone.

12. The flexible nozzle system of claim 9, wherein the at least two arm regions is six arm regions.

13. The flexible nozzle system of claim 9, wherein the sidewalls of each of the at least two arm regions are sloped between the top surface of the body and a bottom surface of the body.

14. The flexible nozzle system of claim 9, wherein the body has outer circumference defining a shape of the body.

15. The flexible nozzle system of claim 14, wherein the shape of the body is circular.

16. The flexible nozzle system of claim 9, further comprising a plug for selectively covering and uncovering an opening in the outlet.

17. The flexible nozzle system of claim 9, wherein a shape of the opening is one of a star, a flower and a sun.
